(19) United States
(12) Patent Application Publication
(10) Pub. No.: US 2020/0395580 A1
(43) Pub. Date: Dec. 17, 2020

(54) BATTERY

(71) Applicant: Dongguan NVT Technology Limited, Dongguan (CN)

(72) Inventor: Minggao Yao, Dongguan (CN)

(21) Appl. No.: 16/899,777

(22) Filed: Jun. 12, 2020

(30) Foreign Application Priority Data
Jun. 14, 2019 (CN) 201910516251.8

(51) Int. Cl. H01M 2/02; H01M 2/08

(52) U.S. Cl. CPC H01M 2/0277; H01M 2/08; H01M 2/0275

(57) ABSTRACT

A battery includes a battery pocket, a sealing part, an electrode assembly, a terminal assembly, a first isolating portion and a second isolating portion. The sealing part is formed at a top surface of the battery pocket. The electrode assembly is received in the battery pocket An end of the terminal assembly is formed inside the sealing part and electrically connected to the electrode assembly, and another end of the terminal assembly is disposed out of the sealing part. The first isolating portion and the second isolating portion are disposed in the sealing part, and a portion of the first isolating portion and a portion of the second isolating portion are extend out of the sealing part. The terminal assembly is disposed between the first isolating portion and the second isolating portion.

### FIELD

The present disclosure generally relates to batteries.

### BACKGROUND

In a soft pack battery, insulation between a sealing area of an aluminum plastic film and electrode tabs may raise problems during packaging of the battery. In order to solve this problem, an insulating tape is needed. Specifically, before the electrode tabs are bent, the insulating tape is first applied on a surface of the battery. Thus, short circuit or electric leakage caused by the electrode tabs contacting the sealing area may be avoided. However, the use of insulating tape increases the complexity and cost in manufacturing.

### SUMMARY

What is needed, is a battery to isolate the electrode tab from the sealing part.

The present disclosure provides a battery. The battery includes a battery pocket, a sealing part, an electrode assembly, a terminal assembly, a first isolating portion and a second isolating portion. The sealing part is formed at a top surface of the battery pocket. The electrode assembly is received in the battery pocket An end of the terminal assembly is formed inside the sealing part and electrically connected to the electrode assembly, and another end of the terminal assembly is disposed out of the sealing part. t. The first isolating portion and the second isolating portion are disposed in the sealing part, and a portion of the first isolating portion and a portion of the second isolating portion are extend out of the sealing part. The terminal assembly is disposed between the first isolating portion and the second isolating portion.

In one embodiment, the second isolating portion includes a first section and a second section connected to the first section. The first section is disposed in the sealing part. The second section extends from the first section to a side away from the electrode assembly and is disposed out of the sealing part, the second section is bent and covers the sealing part.

In one embodiment, the second isolating portion further includes a crease. The crease is disposed between the first section and the second section. The second section is bent along the crease and covers the sealing part.

In one embodiment, a portion of the first isolating portion disposed in the sealing part is connected to the first section by soldering.

In one embodiment, the battery pocket further includes the top surface. The sealing part divides the top surface into a first side surface and a second side surface. The first side surface and the second side surface are respectively disposed at two sides of the sealing part. The second section is bent and covers the sealing part and at least a portion of the first side surface.

In one embodiment, the terminal assembly includes a first terminal and a second terminal. The first terminal and the second terminal are electrically connected to the electrode assembly. The first isolating portion includes a first isolating plate and a second isolating plate spaced apart from each other. The first terminal is disposed between the first isolating plate and the second isolating portion, and the second terminal is disposed between the second isolating plate and the second isolating portion.

In one embodiment, a width of the second isolating portion is greater than a distance between the first terminal and the second terminal.

In one embodiment, the second isolating portion includes a third isolating plate and a fourth isolating plate spaced apart from each other. The first terminal is disposed between the first isolating plate and the third isolating plate, and the second terminal is disposed between the second isolating plate and the fourth isolating plate.

In one embodiment, at least one of the first isolating plate, the second isolating plate, the third isolating plate and the fourth isolating plate is T-shaped.

In one embodiment, the first isolating portion and the second isolating portion are asymmetric with respect to each other.

In the present disclosure, the terminal assembly is disposed between the first isolating portion and the second isolating portion to isolate the terminal assembly from the sealing part. The second isolating portion includes the crease. The crease is disposed between the first section and the second section. In this way, the second section is bent along the crease and covers the sealing and the first side surface, to isolate the terminal assembly from the sealing part. Any short circuits or electric leakage caused by the terminal assembly bending and contacting the sealing part are avoided. The safety of the battery is improved. The crease prevents the second section from rebounding. In addition, due to the bending performance of the second isolating portion, the terminal assembly is isolated from the sealing part. Thus, the second isolating portion can be substituted for the traditional adhesive tape, so that the material required, and attaching processes and costs are reduced. At the same time, the second section is bent and covers the sealing part and the first side surface, which can shorten the length of the terminal assembly. In this way, while a total length of the electrode assembly is unchanged, a length of the electrode assembly is increased by a decrease in a length of the terminal assembly, thereby increasing the capacity of the electrode assembly.

### BRIEF DESCRIPTION OF THE DRAWINGS

Implementations of the present disclosure will now be described, by way of embodiments, with reference to the attached figures.

FIG. 1 is a view of a battery in one embodiment of.

FIG. 2 is a view of a portion of the battery in FIG. 1.

FIG. 3 is a rear view of the portion of the battery shown in FIG. 2.

FIG. 4 is a view of another embodiment of a portion of the battery shown in FIG. 1.

FIG. 5 is a front view of the portion of the battery shown in FIG. 3 and FIG. 4.

FIG. 6 is a view of another embodiment of a portion of the battery shown in FIG

FIG. 7 is a view of another embodiment of a portion of the battery shown in FIG. 1.

FIG. 8 is a view of another embodiment of a portion of the battery shown in FIG. 1.

FIG. 9 is a front view of the portion of the battery shown in FIG. 9.

FIG. 10 is a view of another embodiment of a portion of the battery shown in FIG

FIG. 11 is a view of another embodiment of a portion of the battery shown in FIG. 10.

FIG. 12 is a view of another embodiment of a portion of the battery shown in FIG. 11.

FIG. 13 is a view of another embodiment of a portion of the battery shown in FIG. 10.

FIG. 14 is a rear view of the portion of the battery shown in FIG. 13.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

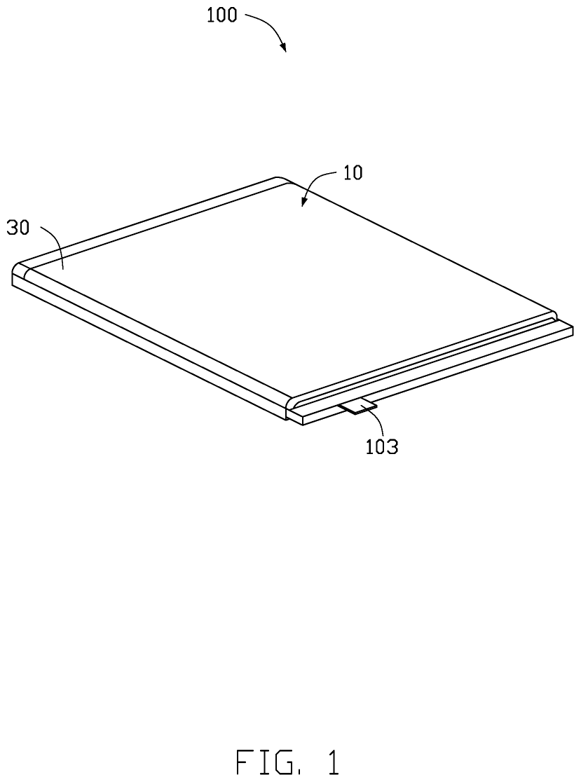

FIG. 1 illustrates an embodiment of a battery 100.

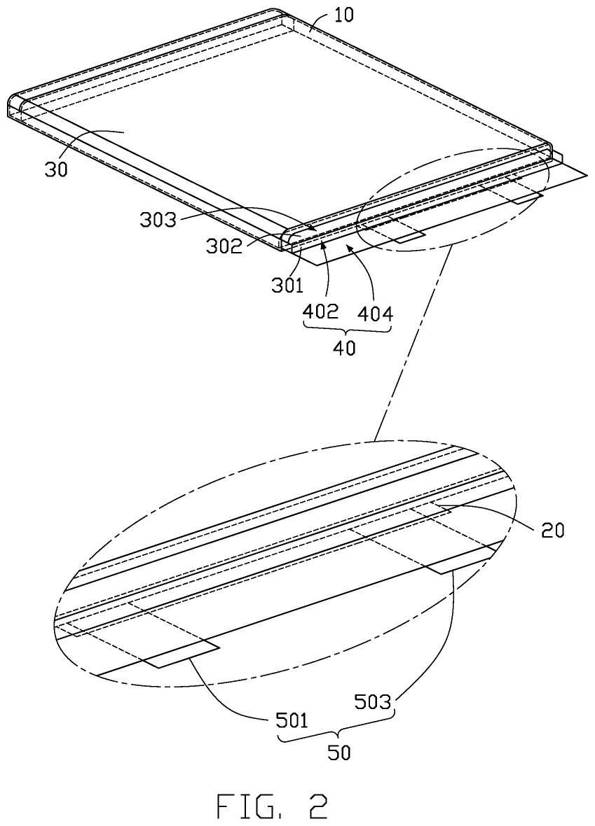

Referring to FIGS. 1 and 2, the battery 100 includes an electrode assembly 10, a battery pocket 30, and a terminal assembly 50.

The electrode assembly 10 is completely received in the battery pocket 30. The battery 100 further includes a sealing part 301. The sealing part 301 is formed at a top surface 303 of the battery pocket 30. The sealing part 301 is a portion of the battery pocket 30. In at least one embodiment, the battery pocket 30 is an aluminum plastic film.

An end of the terminal assembly 50 is formed inside the sealing part 301 and electrically connected to the electrode assembly 10. Another end of the terminal assembly 50 far away from the electrode assembly 10 is disposed out of the sealing part 301.

Further, the battery 100 includes a protrusion 103. The protrusion 103 connects to the electrode assembly 10. The electrode assembly 10 can be electrically connected to a flexible circuit board (not shown) through the protrusion 103.

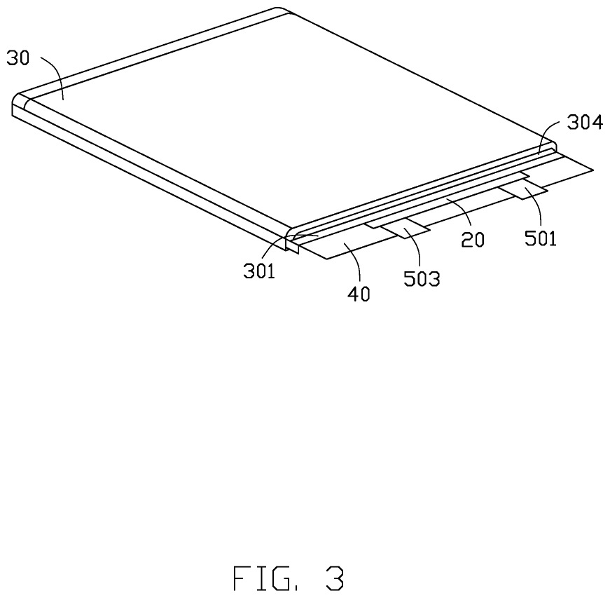

Referring to FIGS. 2 and 3, in at least one embodiment, the battery 100 further includes a first isolating portion 20 and a second isolating portion 40. The first isolating portion 20 and the second isolating portion 40 are disposed in the sealing part 301, and a portion of the first isolating portion 20 and a portion of the second isolating portion 40 are extend out of the sealing part 301. The terminal assembly 50 is disposed between the first isolating portion 20 and the second isolating portion 40 to isolate the terminal assembly 50 from the sealing part 301. The first isolating portion 20 and the second isolating portion 40 are asymmetric with respect to each other.

In another embodiment, the first isolating portion 20 and the second isolating portion 40 may be symmetrical with respect to each other.

Referring to FIG. 2, a portion of the first isolating portion 20 is disposed in the sealing part 301. The second isolating portion 40 includes a first section 402 and a second section 404 connected to the first section 402. The first section 402 is disposed in the sealing part 301. The second section 404 extends from the first section 402 to a side away from the electrode assembly 10. The second section 404 is bent and covers all or a portion of the sealing part 301 to avoid short circuits or electric leakage caused by the terminal assembly 50 bending and contacting the sealing part 301.

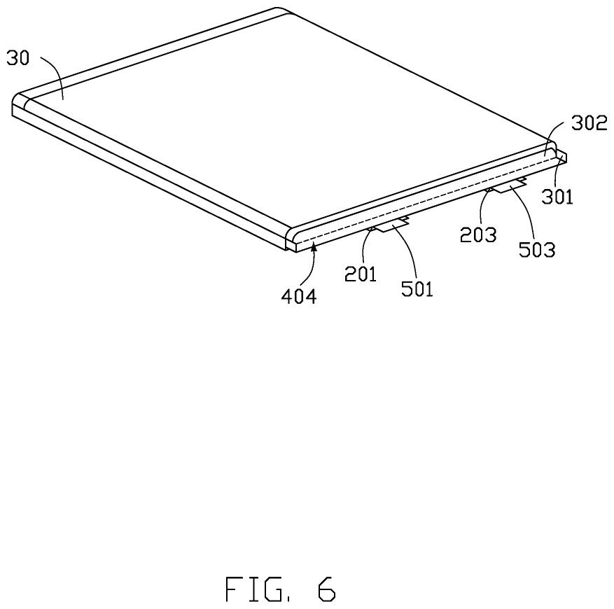

Referring to FIGS. 2 and 3, the battery pocket 30 further includes the top surface 303. The sealing part 301 divides the top surface 303 into a first side surface 302 and a second side surface 304. The first side surface 302 and the second side surface 304 are respectively disposed at two sides of the sealing part 301. The first side surface 302 is close to the second isolating portion 40 relative to the second side surface 304. The second side surface 304 is close to the first isolating portion 20 relative to the first side surface 302. A vertical distance from an edge of the first side surface 302 away from the sealing part 301 to the sealing part 301 is greater than a vertical distance of an edge of the second side surface 304 away from the sealing part 301 to the sealing part 301. The second section 404 is bent and covers the sealing part 301 and all or a portion of the first side surface 302 (see FIG. 6). In at least one embodiment, the first isolating portion 20 and the second isolating portion 40 are insulating films. The first isolating portion 20 is connected to the first section 402 by ultrasonic welding, and a portion of the first isolating portion 20 is enclosed in the sealing part 301. In another embodiment, a material of the first isolating portion 20 and the second isolating portion 40 may be insulating tapes, PE films (polyethylene films), PET films (polyethylene terephthalate films), mica products and other insulation materials. The first isolating portion 20 and the second isolating portion 40 may be connected by adhesive or thermal fusion welding.

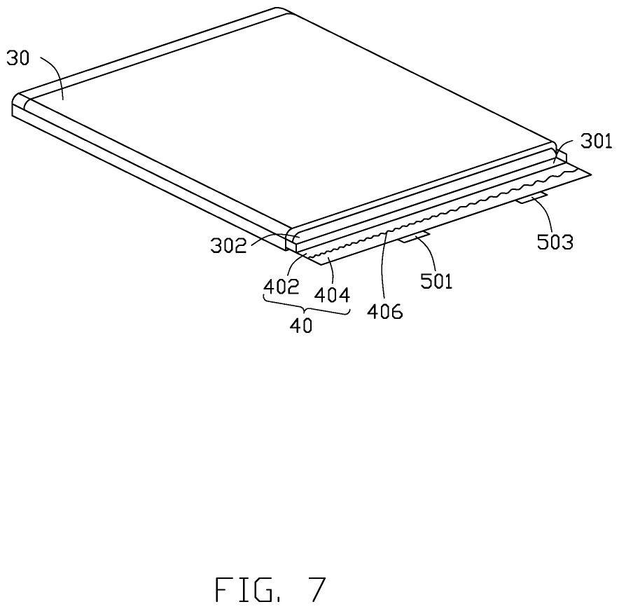

Referring to FIG. 7, in one embodiment, the second isolating portion 40 further includes a crease 406. The crease 406 is disposed between the first section 402 and the second section 404. In this way, the second section 404 is bent along the crease 406 and covers the sealing part 301 and the first side surface 302 to avoid short circuits or electric leakage caused by the terminal assembly 50 bending and contacting the sealing part 301 The existence of the crease 406 facilitates the bending of the second section 404 and prevents the second section 404 from rebounding, and avoids breakage of the terminal assembly 50 due to bending stress.

Referring to FIG. 2, the terminal assembly 50 includes a first terminal 501 and a second terminal 503. The first terminal 501 and the second terminal 503 are disposed on the same side of the electrode assembly 10.

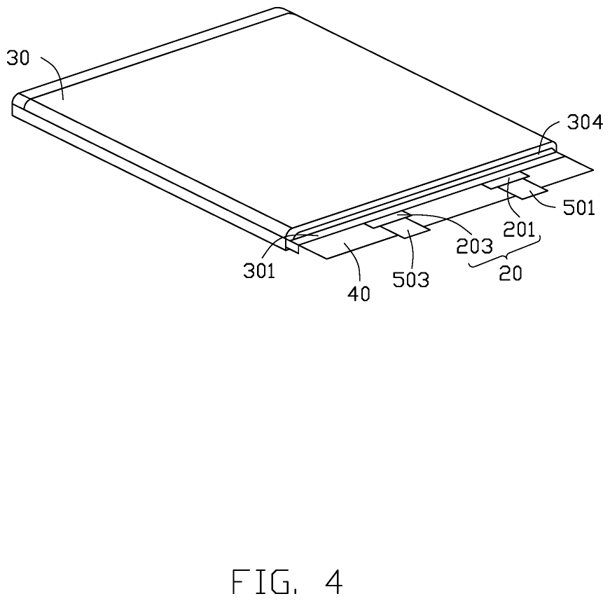

Referring to FIG. 4, in one embodiment, the first isolating portion 20 includes a first isolating plate 201 and a second isolating plate 203 spaced apart from each other. The first terminal 501 is disposed between the first isolating plate 201 and the second isolating portion 40, and the second terminal 503 is disposed between the second isolating plate 203 and the second isolating portion 40. A width of the second isolating portion 40 is greater than a distance between the first terminal 501 and the second terminal 503.

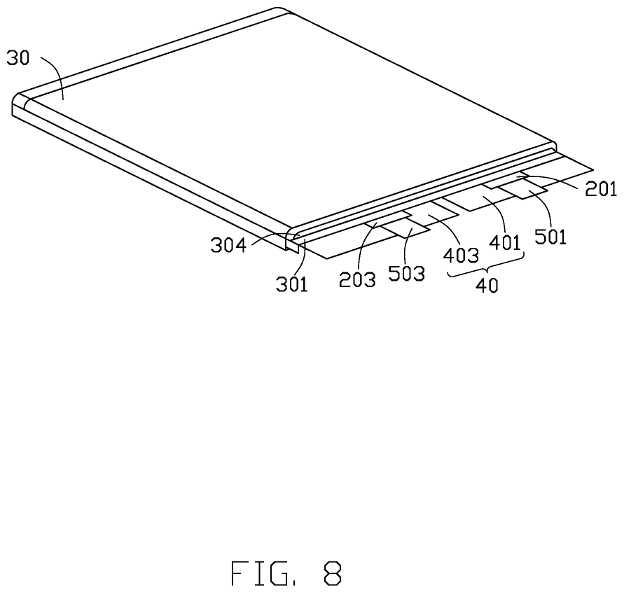

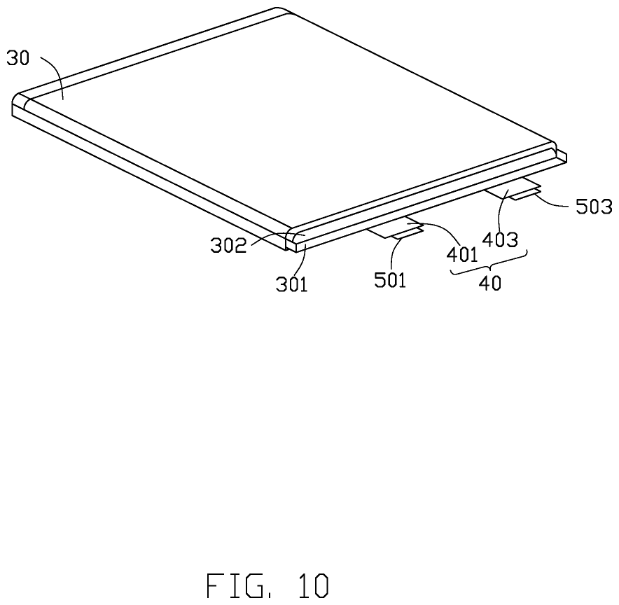

Referring to FIGS. 8 and 10, in one embodiment, the second isolating portion 40 includes a third isolating plate 401 and a fourth isolating plate 403 spaced apart from each other. The first terminal 501 is disposed between the first isolating plate 201 and the third isolating plate 401, and the second terminal 503 is disposed between the second isolating plate 203 and the fourth isolating plate. 403. In one embodiment, the third isolating plate 401 and the fourth isolating plate 403 have the same structure. A width of the third isolating plate 401 is slightly larger than a width of the first terminal 501 (see FIG. 10).

In other embodiments, the width of the third isolating plate 401 may be adapted adjusted according to actual needs. For example, the width of the third isolating plate 401 shown in FIG. 8 is much larger than the width of the first terminal 501.

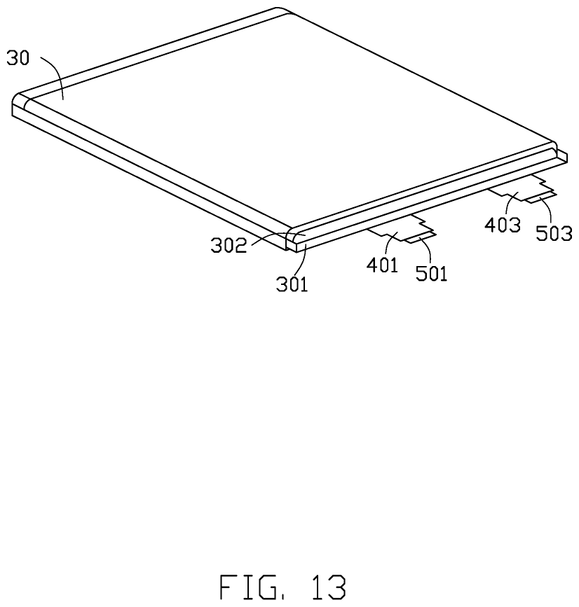

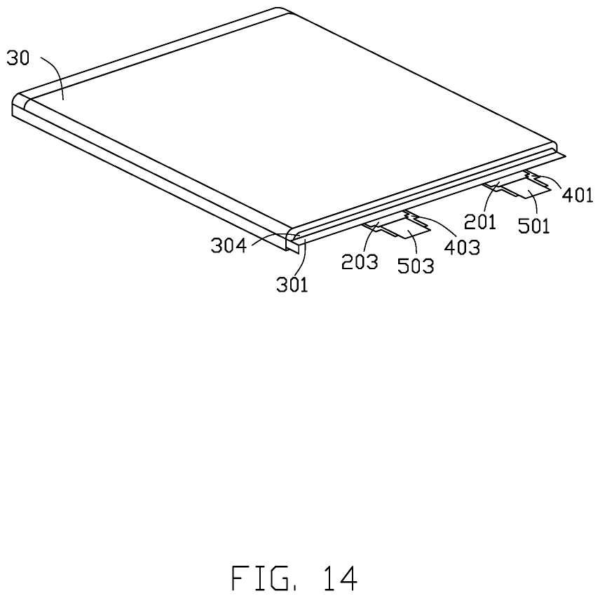

Referring to FIGS. 13 and 14, in another embodiment, the first isolating plate 201 and the third isolating plate 401 are T-shaped, or the second isolating plate 203 and the fourth isolating plate 403 are T-shaped, or the first isolating plate 201, the second isolating plate 203, the third isolating plate 401 and the fourth isolating plate 403 are T-shaped. That is, a width of an end of the first isolating plate 201 near the sealing part 301 is larger than a width of an end of the first isolating plate 201 far from the sealing part 301 so that the first isolating plate 201 is T-shaped. Or, a width of an end of the second isolating plate 203 near the sealing part 301 is larger than a width of an end of the second isolating plate 203 far from the sealing part 301 so that the second isolating plate 203 is T-shaped. Or, a width of an end of the third isolating plate 401 near the sealing part 301 is larger than a width of an end of the third isolating plate 401 far from the sealing part 301 so that the third isolating plate 401 is T-shaped. Or, a width of an end of the fourth isolating plate 403 near the sealing part 301 is larger than a width of an end of the fourth isolating plate 403 far from the sealing part 301 so that the fourth isolating plate 403 is T-shaped. In this way, due to the T-shapes increase the clamping force of the sealing part 301 on the electrode tabs and the isolating plates, ensure the welding strength of the sealing part 301 to prevent delamination, and enhance the safety of the battery 100.

Further, a length of the third isolating plate 401 is longer than a length of the first isolating plate 201, and a length of the fourth isolating plate 403 is longer than a length of the second isolating plate 203. In this way, when the first terminal 501 is bent in the direction of the first side surface 302, the first terminal 501 can be bent from the boundary of the first isolating plate 201 to reduce damage to the first terminal 501 caused by bending stress. When the second terminal 503 is bent in the direction of the first side surface 302 the second terminal 503 can be bent from the boundary of the second isolating plate 203 to reduce damage to the second terminal 503 caused by bending stress.

In the EMBODIMENTS herein, dimensions, materials, and proportions of electrode assembly, first isolating portion, battery pocket, second isolating portion, terminal assembly, and the like are not limited, and may be selected according to actual needs.

### Embodiment 1

Referring to FIGS. 2 and 3, the battery 100 includes an electrode assembly 10, a first isolating portion 20, a battery pocket 30, a second isolating portion 40 and a terminal assembly 50.

The electrode assembly 10 is completely received in the battery pocket 30. The battery 100 further includes a sealing part 301. The sealing part 301 is formed at a top surface 303 of the battery pocket 30.

An end of the terminal assembly 50 is formed inside the sealing part 301 and electrically connected to the electrode assembly 10. Another end of the terminal assembly 50 far away from the electrode assembly 10 is disposed out of the sealing part 301. The battery pocket 30 includes the top surface 303. The sealing part 301 divides the top surface 303 into a first side surface 302 and a second side surface 304. The first side surface 302 and the second side surface 304 are respectively disposed at two sides of the sealing part 301. The first side surface 302 is close to the second isolating portion 40 relative to the second side surface 304. The second side surface 304 is close to the first isolating portion 20 relative to the first side surface 302. The vertical distance from an edge of the first side surface 302 away from the sealing part 301 to the sealing part 301 is greater than the vertical distance of an edge of the second side surface 304 away from the sealing part 301 to the sealing part 301. In EMBODIMENT 1, the terminal assembly 50 includes a first terminal 501 and a second terminal 503. The first terminal 501 and the second terminal 503 are disposed on the same side of the electrode assembly 10.

The first isolating portion 20 and the second isolating portion 40 are disposed in the sealing part 301, and a portion of the first isolating portion 20 and a portion of the second isolating portion 40 are extend out of the sealing part 301. The first terminal 501 and the second terminal 503 are disposed between the first isolating portion 20 and the second isolating portion 40.

A portion of the first isolating portion 20 is disposed in the sealing part 301. The second isolating portion 40 includes a first section 402 and a second section 404 connected to the first section 402. The first section 402 is disposed in the sealing part 301. The second section 404 extends from the first section 402 to a side away from the electrode assembly 10. The second section 404 is bent and covers the sealing part 301. The first isolating portion 20 disposed in the sealing part 301 is connected to the first section 402 by ultrasonic welding or thermocompression welding.

### Embodiment 2

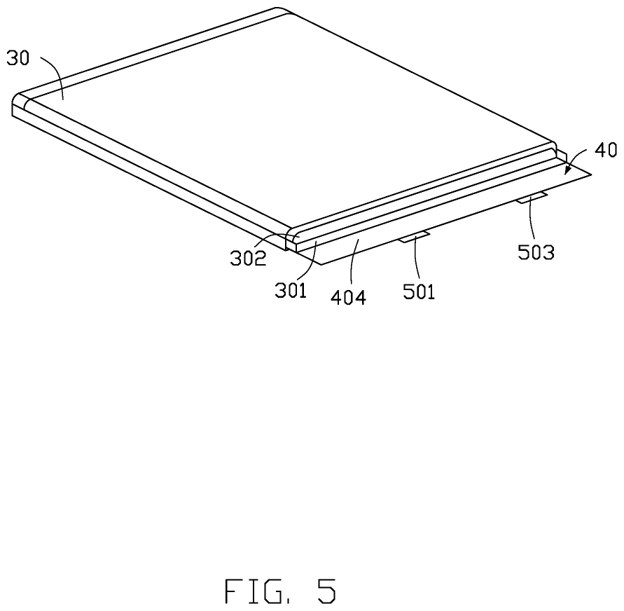

Referring to FIG. 5, difference between the battery 100 of EMBODIMENT 2 and the battery 100 of EMBODIMENT 1 is the second section 404. In EMBODIMENT 2, the second section 404 is bent and covers the sealing part 301 and the first side surface 302.

### Embodiment 3

Referring to FIG. 7, difference between the battery 100 of EMBODIMENT 3 and the battery 100 of EMBODIMENT 2 is the second isolating portion 40. In EMBODIMENT 3, the second isolating portion 40 further includes a crease 406. The crease 406 is disposed between the first section 402 and the second section 404. The second section 404 is bent along the crease 406 and covers the sealing part 301 and the first side surface 302 to avoid short circuits or electric leakage caused by the terminal assembly 50 bending and contacting the sealing part 301 The existence of the crease 406 facilitates the bending of the second section 404 and prevents the second section 404 from rebounding, and avoids breakage of the terminal assembly 50 due to bending stress.

### Embodiment 4

Referring to FIGS. 4 and 5, difference between the battery 100 of EMBODIMENT 4 and the battery 100 of EMBODIMENT 1 is the first isolating portion 20. In EMBODIMENT 4, the first isolating portion 20 includes a first isolating plate 201 and a second isolating plate 203 spaced apart from each other. The first terminal 501 is disposed between the first isolating plate 201 and the second isolating portion 40, and the second terminal 503 is disposed between the second isolating plate 203 and the second isolating portion 40. The width of the second isolating portion 40 is greater than the distance between the first terminal 501 and the second terminal 503.

### Embodiment 5

Referring to FIGS. 4 and 6, difference between the battery 100 of EMBODIMENT 5 and the battery 100 of EMBODIMENT 2 is the first isolating portion 20. In EMBODIMENT 5, the first isolating portion 20 includes a first isolating plate 201 and a second isolating plate 203 spaced apart from each other. The first terminal 501 is disposed between the first isolating plate 201 and the second isolating portion 40, and the second terminal 503 is disposed between the second isolating plate 203 and the second isolating portion 40. The width of the second isolating portion 40 is greater than the distance between the first terminal 501 and the second terminal 503.

### Embodiment 6

Referring to FIGS. 4 and 7, difference between the battery 100 of EMBODIMENT 6 and the battery 100 of EMBODIMENT 3 is the first isolating portion 20. In EMBODIMENT 6, the first isolating portion 20 includes a first isolating plate 201 and a second isolating plate 203 spaced apart from each other. The first terminal 501 is disposed between the first isolating plate 201 and the second isolating portion 40, and the second terminal 503 is disposed between the second isolating plate 203 and the second isolating portion 40. The width of the second isolating portion 40 is greater than the distance between the first terminal 501 and the second terminal 503.

### Embodiment 7

Referring to FIG. 10, difference between the battery 100 of EMBODIMENT 7 and the battery 100 of EMBODIMENT 4 is the second isolating portion 40. In EMBODIMENT 7, the second isolating portion 40 includes a third isolating plate 401 and a fourth isolating plate 403 spaced apart from each other. The first terminal 501 is disposed between the first isolating plate 201 and the third isolating plate 401, and the second terminal 503 is disposed between the second isolating plate 203 and the fourth isolating plate. 403. In EMBODIMENT 7, the third isolating plate 401 and the fourth isolating plate 403 have the same structure. The width of the third isolating plate 401 is slightly larger than the width of the first terminal 501.

### Embodiment 8

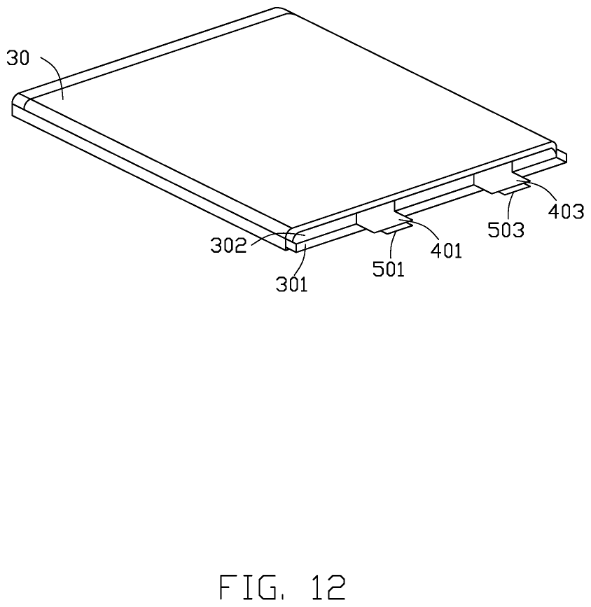

Referring to FIG. 12, difference between the battery 100 of EMBODIMENT 8 and the battery 100 of EMBODIMENT 5 is the second isolating portion 40. In EMBODIMENT 8, the second isolating portion 40 includes a third isolating plate 401 and a fourth isolating plate 403 spaced apart from each other. The first terminal 501 is disposed between the first isolating plate 201 and the third isolating plate 401, and the second terminal 503 is disposed between the second isolating plate 203 and the fourth isolating plate 403. In EMBODIMENT 8, the third isolating plate 401 and the fourth isolating plate 403 have the same structure. The width of the third isolating plate 401 is slightly larger than the width of the first terminal 501.

### Embodiment 9

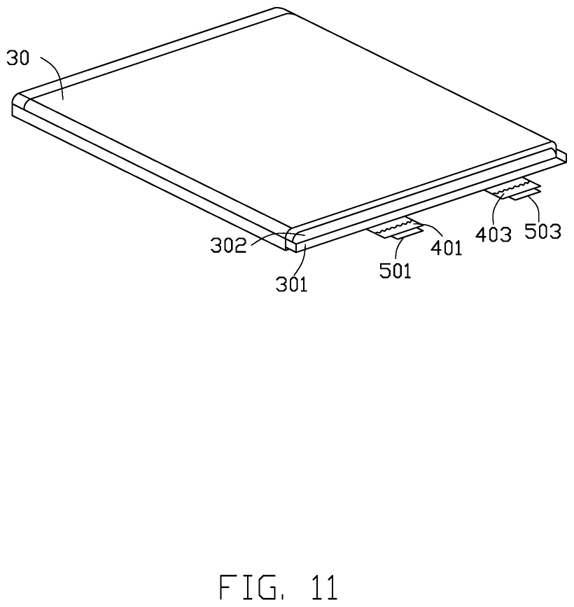

Referring to FIG. 11, difference between the battery 100 of EMBODIMENT 9 and the battery 100 of EMBODIMENT 6 is the second isolating portion 40. In EMBODIMENT 9, the second isolating portion 40 includes a third isolating plate 401 and a fourth isolating plate 403 spaced apart from each other. The first terminal 501 is disposed between the first isolating plate 201 and the third isolating plate 401, and the second terminal 503 is disposed between the second isolating plate 203 and the fourth isolating plate. 403. In EMBODIMENT 9, the third isolating plate 401 and the fourth isolating plate 403 have the same structure. The width of the third isolating plate 401 is slightly larger than the width of the first terminal 501.

### Embodiment 10

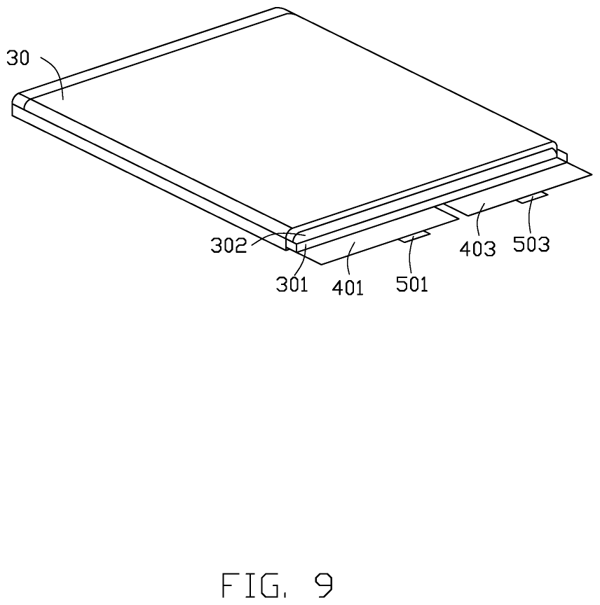

Referring to FIGS. 8 and 9, difference between the battery 100 of EMBODIMENT 10 and the battery 100 of EMBODIMENT 7 is the third isolating plate 401. In EMBODIMENT 10, the width of the third isolating plate 401 is much larger than the width of the first terminal 501. That is, the width of the third isolating plate 401 in EMBODIMENT 10 is larger than the width of the third isolating plate 401 in EMBODIMENT 7.

### Embodiment 11

Referring to FIGS. 13 and 14, difference between the battery 100 of EMBODIMENT 11 and the battery 100 of EMBODIMENT 8 is the first isolating plate 201, the second isolating plate 203, the third isolating plate 401 and the fourth isolating plate 403. In EMBODIMENT 11, the first isolating plate 201, the second isolating plate 203, the third isolating plate 401 and the fourth isolating plate 403 are all T-shaped. All such T-shapes increase the clamping force of the sealing part 301 on the electrode tabs and the isolating plates, ensure the welding strength of the sealing part 301 and prevent to delamination, and enhance the safety of the battery 100.

In another embodiment, the length of the third isolating plate 401 in EMBODIMENTS 7 to 11 is longer than the length of the first isolating plate 201, and the length of the fourth isolating plate 403 in EMBODIMENTS 7 to 11 is longer than the length of the second isolating plate 203. In this way, when the first terminal 501 is bent in the direction of the first side surface 302, the first terminal 501 can be bent from the boundary of the first isolating plate 201 to reduce damage to the first terminal 501 caused by bending stress. When the second terminal 503 is bent in the direction of the first side surface 302, the second terminal 503 can be bent from the boundary of the second isolating plate 203 to reduce damage to the second terminal 503 caused by bending stress.

In summary, the terminal assembly 50 is disposed between the first isolating portion 20 and the second isolating portion 40 to isolate the terminal assembly 50 from the sealing part 301. The second isolating portion 40 includes the crease 406. The crease 406 is disposed between the first section 402 and the second section 404. In this way, the second section 404 is bent along the crease 406 and covers the sealing part 301 and the first side surface 302, to isolate the terminal assembly 50 from the sealing part 301. Any short circuits or electric leakage caused by the terminal assembly 50 bending and contacting the sealing part 301 are avoided. The safety of the battery 100 is improved. The crease 406 prevents the second section 404 from rebounding, due to the bending performance of the second isolating portion 40, the terminal assembly 50 is isolated from the sealing part 301. Thus, the second isolating portion 40 can be substituted for the traditional adhesive tape, so that the material required, and attaching processes and costs are reduced. At the same time, the second section 404 is bent and covers the sealing part 301 and the first side surface 302, which can shorten the length of the terminal assembly 50. In this way, while a total length of the electrode assembly 10 is unchanged, a length of the electrode assembly 10 is increased by a decrease in a length of the terminal assembly 50, thereby increasing the capacity of the electrode assembly 10.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A battery, comprising:
a battery pocket;
a sealing part, being formed at a top surface of the battery pocket;
an electrode assembly, the electrode assembly receiving in the battery pocket;
a terminal assembly, an end of the terminal assembly being formed inside the sealing part and electrically connected to the electrode assembly, and another end of the terminal assembly is disposed out of the sealing part,
a first isolating portion and a second isolating portion, wherein the first isolating portion and the second isolating portion are disposed in the sealing part, and a portion of the first isolating portion and a portion of the second isolating portion are extend out of the sealing part;
wherein the terminal assembly is disposed between the first isolating portion and the second isolating portion.

2. The battery of claim 1, wherein the second isolating portion comprises a first section and a second section connected to the first section, the first section is disposed in the sealing part, the second section extends from the first section to a side away from the electrode assembly and is disposed out of the sealing part, the second section is bent and covers the sealing part.

3. The battery of claim 2, wherein the second isolating portion further comprises a crease disposed between the first section and the second section, and the second section is bent along the crease and covers the sealing part.

4. The battery of claim 2, wherein a portion of the first isolating portion disposed in the sealing part is connected to the first section by soldering.

5. The battery of claim 2, wherein the battery pocket comprises the top surface, the sealing part divides the top surface into a first side surface and a second side surface, the first side surface and the second side surface are respectively disposed at two sides of the sealing part, and the second section is bent and covers the sealing part and at least a portion of the first side surface.

6. The battery of claim 1, wherein the terminal assembly comprises a first terminal and a second terminal, the first terminal and the second terminal b are electrically connected to the electrode assembly, the first isolating portion comprises a first isolating plate and a second isolating plate spaced apart from each other; the first terminal is disposed between the first isolating plate and the second isolating portion, and the second terminal is disposed between the second isolating plate and the second isolating portion.

7. The battery of claim 6, wherein a width of the second isolating portion is greater than a distance between the first terminal and the second terminal.

8. The battery of claim 6, wherein the second isolating portion comprises a third isolating plate and a fourth isolating plate spaced apart from each other; the first terminal is disposed between the first isolating plate and the third isolating plate, and the second terminal is disposed between the second isolating plate and the fourth isolating plate.

9. The battery of claim 8, wherein at least one of the first isolating plate, the second isolating plate, the third isolating plate, and the fourth isolating plate is T-shaped.

10. The battery of claim 1, wherein the first isolating portion and the second isolating portion are asymmetric with respect to each other.
